(19) United States
(12) Patent Application Publication
(10) Pub. No.: US 2003/0007736 A1
(43) Pub. Date: Jan. 9, 2003

(54) Optical transmission module and optical transceiver

(75) Inventor: Akinori Harada, Kanagawa (JP)

Correspondence Address: SUGHRUE MION, PLLC, 2100 Pennsylvania Avenue, NW, Washington, DC, 20037-3213, US

(73) Assignee: FUJI PHOTO FILM CO., LTD.

(21) Appl. No.: 10/187,784

(22) Filed: Jul. 3, 2002

(30) Foreign Application Priority Data
Jul. 4, 2001 (JP) 2001-203556
Jul. 4, 2001 (JP) 2001-203557

(51) Int. Cl. G02B 6/30; G02B 6/26; G02B 6/12

(52) U.S. Cl. 385/49; 385/45; 385/14

(57) ABSTRACT

An optical transmission module, which can be realized at a low cost without requiring complicated adjustment of an optical axis. Sheet-type polymer optical waveguides are disposed on a substrate. On an end of each polymer optical waveguide, a transparent electrode layer serving as an anode, an organic-compound layer including a light-emitting layer, and a metal electrode layer serving as a cathode are successively overlaid via vapor deposition or the like to form an organic electro-luminescence (EL) element. When the organic EL element is used as a light source in the optical transmission module, the optical waveguide and the light source (the organic EL element) can be easily connected to each other without requiring complicated adjustment of an optical axis and complicated processing of an end surface of the optical waveguide.

### BACKGROUND OF THE INVENTION

1. Field of the Invention

The present invention relates to an optical transmission module and an optical transceiver, and specifically to an optical transmission module which transmits light by introducing light to optical waveguides disposed on a substrate, an optical transmission module which transmits light by introducing light to a fiber image guide, and an optical transceiver.

2. Description of the Related Art

In recent years, as the Internet has become more prevalent and large-scale integration (LSI) techniques have advanced, information processing equipment has been increasingly required to operate more rapidly and have larger capacities. In the next generation of information processing equipment, such as terabit (10¹² bits) class ATM exchanges and massively parallel computers, it is said that signal wiring (interconnections) between equipment, between boards in equipment and between chips in equipment presents an obstacle to improvement of system performance. Optical interconnection utilizing the high speed of light is attracting attention as a way to solve this future problem.

An optical transmission module, which includes a combination of semiconductor light-emitting elements, such as surface LEDs or vertical-cavity surface-emitting lasers (VCSELs), and sheet-type optical waveguides, has been suggested for use in optical parallel processing and optical interconnection.

FIG. 11 shows an example of such an optical transmission module. In an optical transmission module 50, multi-channel (ten channels in this example) VCSELs 56 are mounted on a wiring substrate 54, such as an aluminum nitride (AlN) multilayer wiring substrate, on which plural IC chips 52 for sending and receiving signals (eight IC chips each sending and receiving signals for five channels in this example) are further disposed. The VCSELs 56 are passively connected to multi-channel (twenty channels in this example) polymer optical waveguide films 58 serving as sheet-type optical waveguides, one end surfaces 58A of which are mirror-processed at an angle of 45 degrees.

The other ends of the polymer optical waveguide films 58 are connected to a BF connector interface 62 in a BF connector receptacle 60. When multi-channel (twenty channels in this example) BF connector plugs 66, which are connected to optical fiber arrays 64 comprising plural optical fibers for communication of the multiple channels, are fitted into the BF connector receptacle 60, the VCSELs 56 are connected to the optical fiber arrays 64 via the polymer optical waveguide films 58, the BF connector receptacle 60 and the BF connector plugs 66 so as to enable optical communication.

In this combination of semiconductor light-emitting elements and optical waveguides, however, a position (an optical axis) of each semiconductor light-emitting element must be individually and accurately adjusted with respect to each optical waveguide so that light outputted from the semiconductor light-emitting element is efficiently inputted to the optical waveguide, and each semiconductor light-emitting element must further be fixed on the substrate by a solder, a UV-curable adhesive or the like so that the optical axis does not deviate over time (hereinafter, this fixing process is referred to as a fixing procedure). These processes have prevented reduction in costs.

As with the one end surfaces 58A of the polymer optical waveguide films 58, which are mirror-processed at an angle of 45 degrees in the example shown in FIG. 11, ends of the optical waveguides, to which light outputted from the semiconductor light-emitting elements is inputted, must be processed, whereby reduction in costs has been difficult.

It is difficult to arrange plural semiconductor light-emitting elements in an array so that light is uniformly emitted. Also, in the example shown in FIG. 11, since two polymer optical waveguide films 58, each having twenty channels, are arranged and four VCSELs 56, each having ten channels, are arranged correspondingly thereto, tact time is required for a mounting process, which has prevented reduction in costs.

Further, a bundle of optical fibers, i.e., a fiber image guide formed by bundling plural optical fibers, has conventionally been practically utilized as an endoscope or a guide for light in illumination. Since the fiber image guide was originally developed to transmit images, both ends of the optical fiber are in an image-forming relationship and light signals can be thus transmitted in parallel with a high density. Accordingly, there have been studies looking into use of a combination of the fiber image guide and the VCSEL for parallel processing and optical interconnection.

Specifically, as shown in FIG. 12, light outputted from the VCSEL 100 is condensed substantially in parallel and then emitted into a fiber image guide 102 by micro lenses or the like. In the fiber image guide 102, several to several hundreds of the optical fibers generally form one optical transmission line, and an end of the fiber image guide 102, from which light is outputted, is connected to multi-mode optical fibers 104, each having a large core diameter. The multi-mode optical fibers 104 separate the light, which has been transmitted through the fiber image guide 102, into respective channels and guide the separated light to respective light receiving devices 106.

In this combination of the fiber image guide and the VCSEL, however, in order to condense the light outputted from the VCSEL, optical condensing systems, such as micro lenses, need to be disposed at an end surface of the fiber image guide, and the VCSEL and the optical condensing systems need to be fixed thereon. Therefore, in this case, as with the previously-described case, there have still been problems with regard to achieving accurate adjustment of the fixed positions and to cost.

It is difficult to arrange many semiconductor light-emitting elements, such as VCSELs, in an array so that light is uniformly emitted. For example, when the semiconductor light-emitting elements have been two-dimensionally arranged in an eight-by-eight pattern with a pitch of 250 μm, variation in quantity of light among the elements has been observed. Accordingly, tact time is required for a mounting process, which has prevented reduction in costs.

### SUMMARY OF THE INVENTION

It is an object of the present invention to solve the above-described problems, i.e., to provide an optical transmission module and an optical transceiver, which can be inexpensively realized with an easy mounting process without requiring complicated adjustment of an optical axis.

In order to attain the above object, a first aspect of the present invention is an optical transmission module comprising a substrate, an optical waveguide disposed thereon, and a light-emitting element including an organic material, which is overlaid on the optical waveguide.

In accordance with the first aspect of the present invention, a transparent electrode layer serving as an anode, a light-emitting layer that emits light when a voltage is applied, and an electrode layer serving as a cathode, for example, are successively overlaid on the optical waveguide, which is disposed on the substrate, via vapor deposition or the like to form the light-emitting element including the organic material. Light outputted from the light-emitting element is introduced to the optical waveguide, and transmitted thereby.

When the light-emitting element, which is formed by overlaying the layers on the optical waveguide in this manner, is used as a light source, complicated adjustment of an optical axis and complicated processing of an end surface of the optical waveguide become unnecessary, whereby the optical waveguide and the light source can be easily connected to each other. Since the light-emitting element can be formed by overlaying the layers on the optical waveguide via vapor deposition or the like, a fixing procedure, which has been conventionally required, becomes unnecessary, and the light-emitting element can be easily patterned on the optical waveguide. Thus, plural light-emitting elements can be monolithically integrated with plural optical waveguides and the substrate. Accordingly, a process for mounting the optical transmission module can be considerably shortened, and costs can be reduced.

A second aspect of the present invention is the optical transmission module according to the first aspect, further comprising a light detector, which is overlaid on the optical waveguide.

In accordance with the second aspect of the present invention, a transparent electrode layer serving as an anode, a light-detection layer that detects light emitted therein due to a photoelectric effect, and an electrode layer serving as a cathode, for example, are successively overlaid on the optical waveguide via vapor deposition or the like to form a light detector. As a result, light, which has been outputted from the light-emitting element and transmitted through the optical waveguide, can be detected by the light detector, making the optical transmission module a so-called total module, which can send and receive light.

When the light detector is formed by overlaying the layers on the optical waveguide in this way, in the same manner as the light-emitting element in the first aspect of the present invention, the optical waveguide and the light detector can be easily connected to each other without requiring complicated adjustment of an optical axis and complicated processing of an end surface of the optical waveguide. Since the light detector can be formed by overlaying the layers on the optical waveguide via vapor deposition or the like, a fixing procedure becomes unnecessary, and the light detector can be easily patterned on the optical waveguide. Thus, plural light detectors can be monolithically integrated with plural light-emitting elements and plural optical waveguides. Accordingly, a process for mounting the total module can be considerably shortened, and costs can be reduced.

In order to transmit light efficiently, a third aspect of the present invention is the optical transmission module according to the first or second aspect, wherein the optical waveguide is a polymeric optical waveguide and the light-emitting element is an organic electro-luminescence element.

A fourth aspect of the present invention is an optical transceiver comprising: a substrate; a substantially Y-shaped optical waveguide disposed on the substrate; a light-emitting element including an organic material, which is overlaid on a branch of the Y-shaped optical waveguide; and a light detector, which is overlaid on another branch of the Y-shaped optical waveguide.

In accordance with the fourth aspect of the present invention, the light-emitting element is overlaid on the branch of the Y-shaped optical waveguide disposed on the substrate, and the light detector is overlaid on the another branch thereof, so as to form a so-called optical transceiver. When the light-emitting element and the light detector are formed by overlaying the layers on the Y-shaped optical waveguide in this way, in the same manner as in the first and second aspects of the present invention, the Y-shaped optical waveguide, the light-emitting element and the light detector can be easily connected to each other without requiring complicated adjustment of optical axes and complicated processing of end surfaces of the Y-shaped optical waveguide. Since the light-emitting element and the light detector can be formed by overlaying the layers via vapor deposition or the like, a fixing procedure becomes unnecessary, and the light-emitting element and the light detector can be easily patterned on the Y-shaped optical waveguide. Thus, plural light-emitting elements and plural light detectors can be monolithically integrated with plural Y-shaped optical waveguides. Accordingly, a process for mounting the optical transceiver can be considerably shortened, and costs can be reduced.

In order to transmit light efficiently, a fifth aspect of the present invention is the optical transceiver according to the fourth aspect, wherein the Y-shaped optical waveguide is a polymeric optical waveguide and the light-emitting element is an organic electro-luminescence element.

Further, a sixth aspect of the present invention is an optical transmission module comprising: a fiber image guide, which is formed by bundling plural optical fibers; and a light-emitting clement including an organic material, which is overlaid on an end surface of the fiber image guide.

In accordance with the sixth aspect of the present invention, a transparent electrode layer serving as an anode, a light-emitting layer that emits light when a voltage is applied, and an electrode layer serving as a cathode, for example, are successively overlaid on the end surface of the fiber image guide via vapor deposition or the like to form the light-emitting element including the organic material. Light outputted from the light-emitting element is introduced into the end surface of the fiber image guide, and transmitted through the fiber image guide (through the optical fibers). Alternatively, optical condensing systems may be disposed on the end surface of the fiber image guide and the light-emitting element may be further overlaid thereon, such that the light outputted from the light-emitting element is condensed and emitted into the end surface of the fiber image guide by the optical condensing systems. As the optical fibers, quartz glass optical fibers as well as plastic optical fibers (polymeric optical fibers), using polymethyl methacrylate (PMMA) for cores and using a fluorine resin for clads, can be used.

When the light-emitting element, which is formed by overlaying the layers on the end surface of the fiber image guide via vapor deposition or the like in this manner, is used as a light source, a fixing procedure which has been conventionally required becomes unnecessary, and if a deposition mask is used, the light-emitting element can be easily patterned thereon. Thus, plural light-emitting elements can be integrated with the end surface of the fiber image guide. Accordingly, a process for mounting the optical transmission module can be considerably shortened, and costs can be reduced.

A seventh aspect of the present invention is the optical transmission module according to the sixth aspect, further comprising a light detector which is overlaid on another end surface of the fiber image guide.

In accordance with the seventh aspect of the present invention, a transparent electrode layer serving as an anode, a light-detection layer that detects light emitted therein due to a photoelectric effect, and an electrode layer serving as a cathode, for example, are successively overlaid on the another end surface of the fiber image guide (the end surface thereof on which the light-emitting element is not overlaid) via vapor deposition or the like to form a light detector. As a result, light, which has been outputted from the light-emitting element and transmitted through the fiber image guide, can be detected by the light detector, making the optical transmission module a so-called total module, which can send and receive light.

When the light detector is formed by overlaying the layers on the another end surface of the fiber image guide via vapor deposition or the like in this way, in the same manner as the light-emitting element in the sixth aspect of the present invention, a fixing procedure becomes unnecessary, and the light detector can be easily patterned thereon. Thus, plural light detectors can be integrated with the another end surface of the fiber image guide. Accordingly, a process for mounting the total module can be considerably shortened, and costs can be reduced.

In order to transmit light efficiently, an eighth aspect of the present invention is the optical transmission module according to the sixth or seventh aspect, wherein the optical fibers are polymeric optical fibers and the light-emitting element is an organic electro-luminescence element.

### BRIEF DESCRIPTION OF THE DRAWINGS

FIG. 1 is a cross-sectional view showing an optical transmission module according to a first embodiment of the present invention.

FIG. 2 is a perspective view showing the optical transmission module according to the first embodiment of the present invention.

FIG. 3 is a graph showing general spectrums of propagation loss for polymethyl methacrylate (PMMA) plastic optical fibers (POFs) and total fluorine POFs.

FIG. 4 is a cross-sectional view showing an optical transmission module, which is provided with a laminated light detector, according to a second embodiment of the present invention.

FIG. 5 is a cross-sectional view showing an example of the laminated light detector of FIG. 4 according to the second embodiment of the present invention.

FIG. 6 is a top view showing an optical transmission module, which is provided with a Y-shaped optical waveguide, according to a third embodiment of the present invention.

FIG. 7 is a perspective view showing an optical transmission module according to a fourth embodiment of the present invention.

FIG. 8 is a cross-sectional view showing an organic electro-luminescence (EL) element and its vicinity in the optical transmission module according to the fourth embodiment of the present invention, wherein SELFOC® lenses are used as optical condensing systems.

FIG. 9 is a perspective view showing an optical transmission module, which is provided with a laminated light detector, according to a fifth embodiment of the present invention.

FIG. 10 is a cross-sectional view showing an example of the laminated light detector of FIG. 9 and its vicinity according to the fifth embodiment of the present invention.

FIG. 11 shows a first example of a conventional optical transmission module.

FIG. 12 shows a second example of a conventional optical transmission module using a surface-emitting laser and a fiber image guide.

### DESCRIPTION OF THE PREFERRED EMBODIMENTS

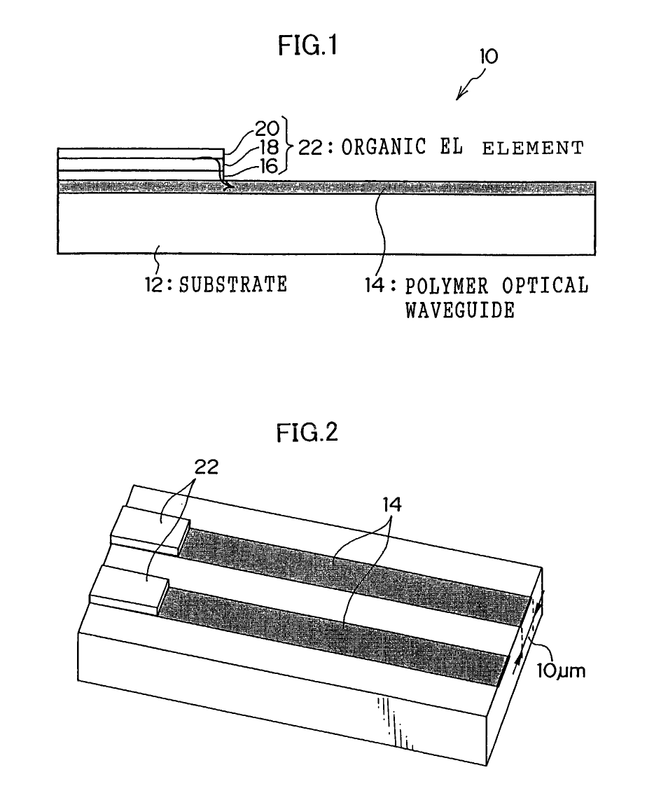

A first embodiment of the present invention will now be described in detail referring to drawings. FIGS. 1 and 2 show an optical transmission module 10 to which the present invention has been applied.

As shown in FIGS. 1 and 2, in the optical transmission module 10, two sheet-type polymer optical waveguides 14, each of which is formed to have a width of about 10 μm, are disposed side by side on a substrate 12. On an end of each polymer optical waveguide 14, a transparent electrode layer 16 serving as an anode, an organic-compound layer 18 including a light-emitting layer, and a metal electrode layer 20 serving as a cathode are successively overlaid to form an organic electro-luminescence (EL) element 22. The transparent electrode layer 16, the organic-compound layer 18 and the metal electrode layer 20 respectively correspond to a first electrode layer, a light-emitting layer and a second electrode layer of the present invention. The organic EL element 22 corresponds to a light-emitting element of the present invention.

In the first embodiment, an example in which two polymer optical waveguides 14 are disposed on the substrate 12 will be described. The number of polymer optical waveguides 14, however, is not limited to two and may be one, three, or greater than three. As components of the optical transmission module 10 other than those mentioned above may be the same as those of a conventional and common optical transmission module, descriptions thereof will be omitted.

Each of the above-mentioned components will now be described.

As the substrate 12, glass substrates and plastic substrates can be used. The substrate 12 is required to have heat resistance, dimensional stability, solvent resistance, electrical insulating properties, processability, low-permeability, low-hygroscopicity and the like, among its general properties.

The polymer optical waveguide 14 is thinly formed from a multi-channel polymer optical waveguide film with a thickness on the order of several micrometers to preserve signal quality. The polymer optical waveguide 14 can be formed by processing a sheet-type material such as polymethyl methacrylate (PMMA) or polyimide using conventionally well-known photolithography and fine-processing techniques.

The transparent electrode layer 16 has a light transmittance of at least 50%, and preferably 70% or more, within a visible-light wavelength range of from 400 nm to 700 nm. As a material for forming the transparent electrode layer 16, any compounds that are well known as transparent electrode materials, including tin oxide, indium tin oxide (ITO), indium zinc oxide and the like, as well as any metal thin films that have a high work function, including gold, platinum and the like, may be used. Alternatively, organic compounds such as polyaniline, polythiophene, polypyrrole and derivatives thereof may be used. In the first embodiment, ITO is used. Transparent conductive films are described in detail in Toumei Doudenmaku no Sintenkai edited by Yutaka Sawada (published by CMC Books Co., Ltd. (1999)), and can be applied to the present invention.

The transparent electrode layer 16 can be patterned on the polymer optical waveguide 14 by a well-known method, such as vacuum deposition or sputtering using a mask.

The organic-compound layer 18 may have a monolayer structure comprising only a light-emitting layer, or have a multilayer structure comprising not only a light-emitting layer but also other suitable layers such as a hole-injection layer, a hole-transportation layer, an electron-injection layer, an electron-transportation layer and/or the like.

Specific examples of a structure (including electrodes) for the organic-compound layer 18 include: a structure comprising an anode, a hole-injection layer, a hole-transportation layer, a light-emitting layer, an electron-transportation layer and a cathode; a structure comprising an anode, a light-emitting layer, an electron-transportation layer and a cathode; a structure comprising an anode, a hole-transportation layer, a light-emitting layer, an electron-transportation layer and a cathode; and the like. Alternatively, plural light-emitting layers, hole-transportation layers, hole-injection layers and/or electron-injection layers may be provided. In the first embodiment, the structure comprising an anode, a hole-transportation layer, a light-emitting layer, an electron-transportation layer and a cathode is used.

These layers can be formed by successively overlaying, from the transparent electrode layer 16 side, thin films of low-molecular organic materials via vapor deposition or the like. If a deposition mask is used, these layers can be easily patterned.

The organic-compound layer 18 is the same as that of a conventionally well-known organic EL element, and a material, a formation method and a thickness of each layer forming the organic-compound layer 18 may thus be the same as those of the conventional organic-compound layer.

Accordingly, a light-emitting material for the light-emitting layer may be any compound that can emit light (fluorescent compounds) and can be appropriately selected depending upon specific objectives. In the first embodiment, an aluminum triquinolinol complex (Alq₃) is used, which is an especially typical example of the light-emitting material for the light-emitting layer.

The metal electrode layer 20 is preferably formed out of a cathode material, examples of which include an alkaline metal such as Li or K, or an alkaline earth metal such as Mg or Ca, having a low work function and thus excellent electron-injection properties; or Ag or Al, which are hard to oxidize and thereby stable. These cathode materials may be used in combination to establish both preservation stability and electron-injection properties in the cathode. In the first embodiment, a combination of Mg and Al is used.

In the same manner as the transparent electrode layer 16, the metal electrode layer 20 can be patterned on the organic-compound layer 18 by a well-known method, such as vacuum deposition or sputtering using a mask.

In the optical transmission module 10 having the above-described structure, when a voltage is applied between the transparent electrode layer 16 and the metal electrode layer 20 of the organic EL element 22 based on signals to be transmitted (transmission signals), the light-emitting layer of the organic-compound layer 18 emits light. The applied voltage may be a stationary voltage (including voltage that generates alternative current, as needed) or pulse voltage.

Light that proceeds to the transparent electrode layer 16 is transmitted through the transparent electrode layer 16. Light that proceeds to the metal electrode layer 20 is reflected thereby because the metal electrode layer 20 functions as a total reflection layer, such that the light proceeds to and is transmitted through the transparent electrode layer 16. In other words, almost all of the emitted light can be emitted to a transparent electrode layer 16 side in the organic EL element 22. The light, which has been transmitted through the transparent electrode layer 16, is introduced from a top surface of the polymer optical waveguide 14 to an interior thereof, and is transmitted by the polymer optical waveguide 14. Thus, in the optical transmission module 10, almost all of the light emitted from the light-emitting layer of the organic EL element 22 based on the transmission signals can be introduced to and transmitted by the polymer optical waveguide 14, and only a small quantity of light is lost.

In this manner, when the organic EL element 22 is used as a light source in the optical transmission module 10 in place of a conventional semiconductor light-emitting element, complicated adjustment of an optical axis and complicated processing of an end surface of the optical waveguide 14, which have been conventionally required, become unnecessary, whereby the optical waveguide 14 and the light source (the organic EL element 22) can be easily connected to each other.

Since the organic EL element 22 can be formed by successively overlaying the layers 16, 18 and 20 via vapor deposition or the like, a fixing procedure, which has been conventionally required, becomes unnecessary, and if a deposition mask is used during the vapor deposition, the organic EL element 22 can be easily patterned on the optical waveguide 14. For example, plural organic EL elements 22 for at least one hundred channels can be simultaneously patterned in a single process, being integrally formed with the optical waveguides 14 and the substrate 12, i.e., integrated therewith monolithically. Accordingly, a process for mounting the optical transmission module 10 can be considerably shortened, and costs can be reduced.

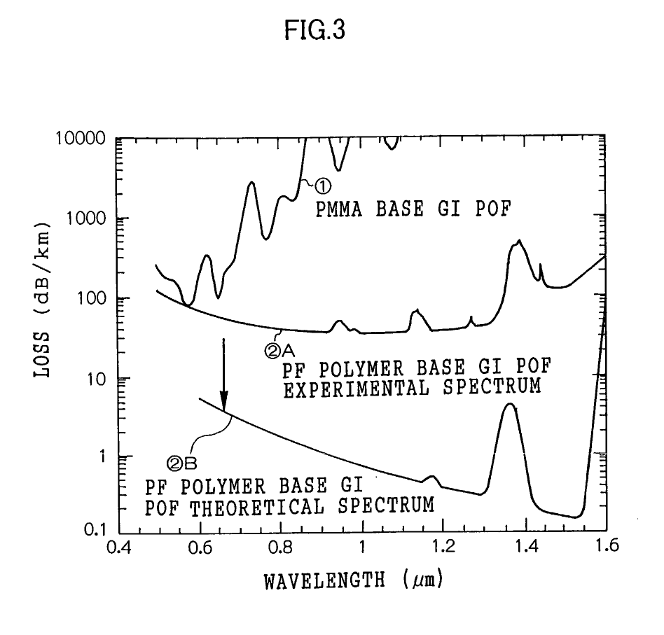

In general, a material for the light-emitting layer of the organic EL element 22, typically Alq₃, emits light efficiently within a wavelength bandwidth of green light (500 to 600 nm). Plastic optical fibers (POFs) using a polymeric material, typically PMMA, which are used for the polymer optical waveguide 14, have a lowest amount of propagation loss, 100 db/km, within a wavelength bandwidth of 550 to 600 nm, as shown by spectrum \mathring{1} in FIG. 3. Spectrums \mathring{2}A and \mathring{2}B are respectively an experimental spectrum and a theoretical spectrum of propagation loss for total fluorine POFs. Although the propagation loss of the total fluorine POFs is lower than that of the polymeric POFs, the total fluorine POFs are more expensive and thus less advantageous in terms of cost than the polymeric POFs.

Therefore, the organic EL element 22 is also suitably used as a light source in order to efficiently transmit light in the polymer optical waveguide 14. When the organic EL element 22 formed as described above was actually driven, it was possible to theoretically confirm a transmission speed of at least 100 Mbps under a drive voltage of 10 V.

In the first embodiment, an example in which only a low-molecular organic material is used in the organic-compound layer 18 has been described. A high-molecular material, however, may be used therein. For example, after the transparent electrode layer 16 has been patterned, a high-molecular material, a typical example thereof being MEH-PPV (a soluble polyphenylene vinylene derivative) which is a π-conjucative polymer, may be patterned via spin coating or an ink jet to form the organic-compound layer 18, and the metal electrode layer 20 is then formed thereon.

Further, in the first embodiment, an example of the optical transmission module for transmitting light has been described. The present invention, however, is not limited to this example, and the optical transmission module can also be structured as in the following second embodiment.

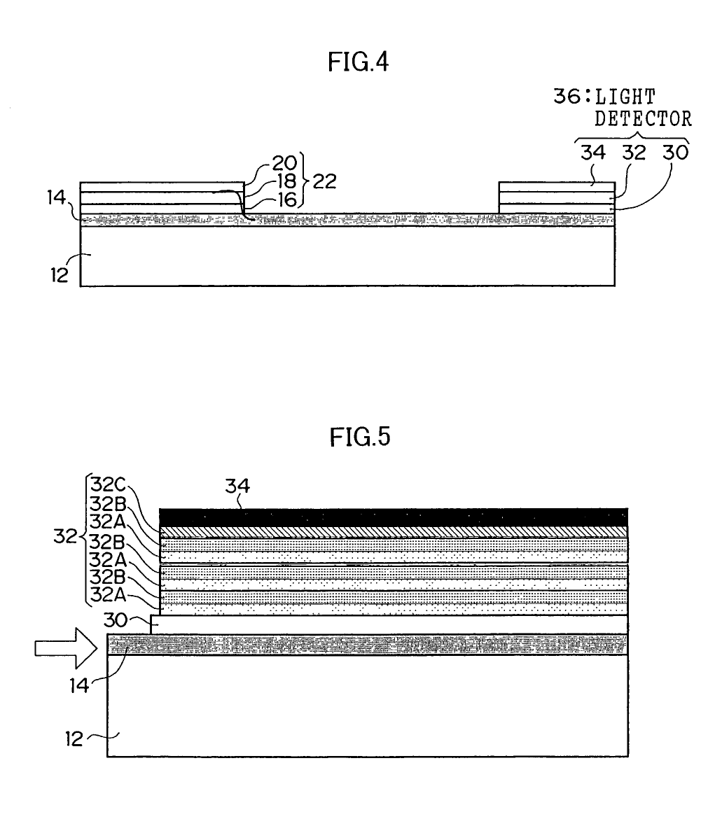

For example, as shown in FIG. 4, in the same manner as in the organic EL element 22, a transparent electrode layer 30 serving as an anode is patterned on the polymer optical waveguide 14 formed on the substrate 12, which is made of glass, and a light-detection layer 32 and a metal electrode layer 34 serving as a cathode are successively overlaid thereon via vapor deposition or the like, so as to form a so-called laminated light detector 36. As a result, light which has been transmitted through the polymer optical waveguide 14 can be detected by the light detector 36, making the optical transmission module a so-called total module, which can send and receive light.

The light-detection layer 32 of the total module utilizes a property in which electric conductivity is increased when light is irradiated to a semiconductor (or an insulator), i.e., a photoconductive effect, which is an internal photoelectric effect, and thus, the light-detection layer 32 is generally formed by overlaying semiconductor layers (or insulating layers). The light-detection layer 32 may be a polycrystalline semiconductor, or may use an organic layer in the same manner as the light-emitting layer.

The photoconductive effect is caused when electrons are excited by a valence band in an energy band or from an impurity level due to light absorption and a carrier of free electrons or holes is generated, and is a phenomenon in which a photocurrent flows when a voltage is applied to a semiconductor. The photocurrent is monitored to detect light which has been transmitted through the polymer optical waveguide 14, so that transmission signals can be obtained.

The light-detection layer 32 may be the same as a conventionally well-known light-detection layer, and a material, a formation method and a thickness of each layer forming the light-detection layer 32 may thus be the same as those of layers in a conventional light-detection layer. In the second embodiment, for example, as shown in FIG. 5, the light-detection layer 32 is formed by repeatedly and successively overlaying, from the transparent electrode layer 30 side, a copper phthalocyanine (CuPc) layer 32A and a 3,4,9,10-perylene tetracarboxylic acid bis-benzimidazole (PTCBI) layer 32B three times (i.e., three CuPc layers 32A and three PTCBI layers 32B are alternatingly overlaid with a CuPc layer 32A as the first layer and a PTCBI layer 32B as the sixth layer), and further overlaying a bathocuproin (BCP) layer 32C thereon.

In this way, when the light detector 36 is formed in the same laminated manner as the above-described organic EL element 22, the polymer optical waveguide 14 and the light detector 36 can be easily connected to each other without requiring complicated adjustment of an optical axis and complicated processing of the end surface of the optical waveguide 14. Since the light detector 36 can be formed by successively overlaying the layers 30, 32 and 34 via vapor deposition or the like, a fixing procedure becomes unnecessary, and if a deposition mask is used, the light detector 36 can be easily patterned on the optical waveguide 14. Thus, plural light detectors 36 can be monolithically integrated with the organic EL elements 22 and the polymer optical waveguides 14. Accordingly, a process for mounting the total module can be shortened, and costs can be reduced.

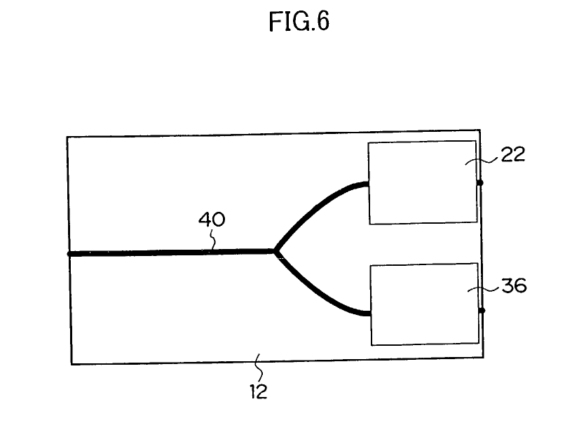

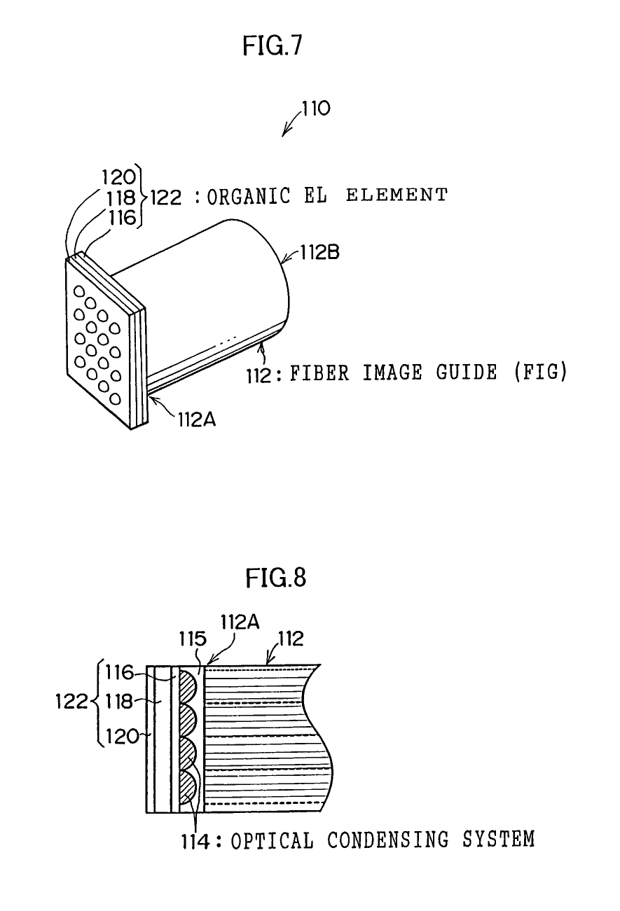

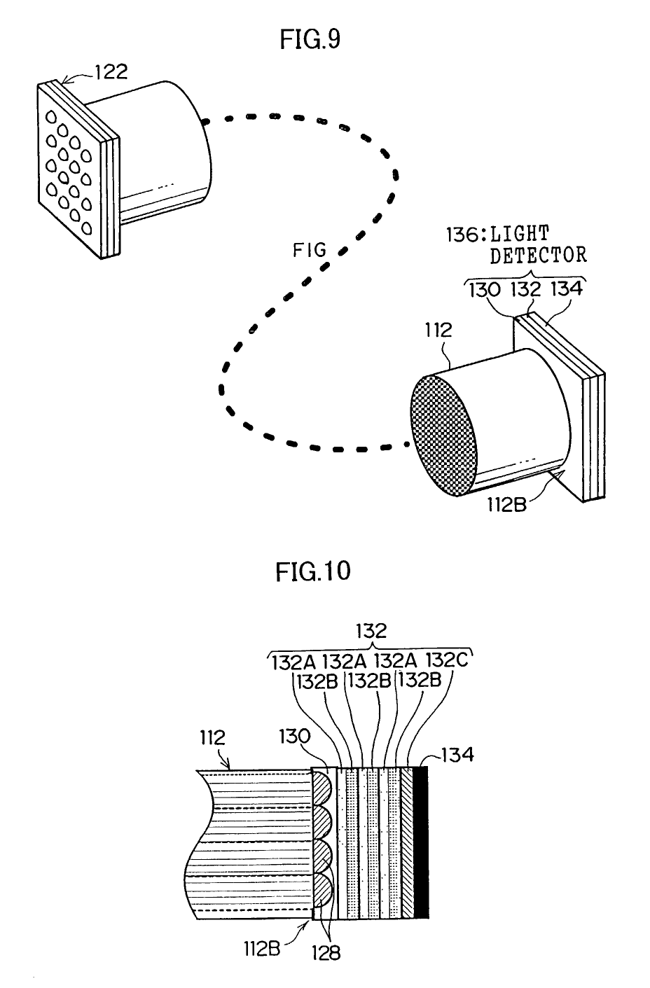

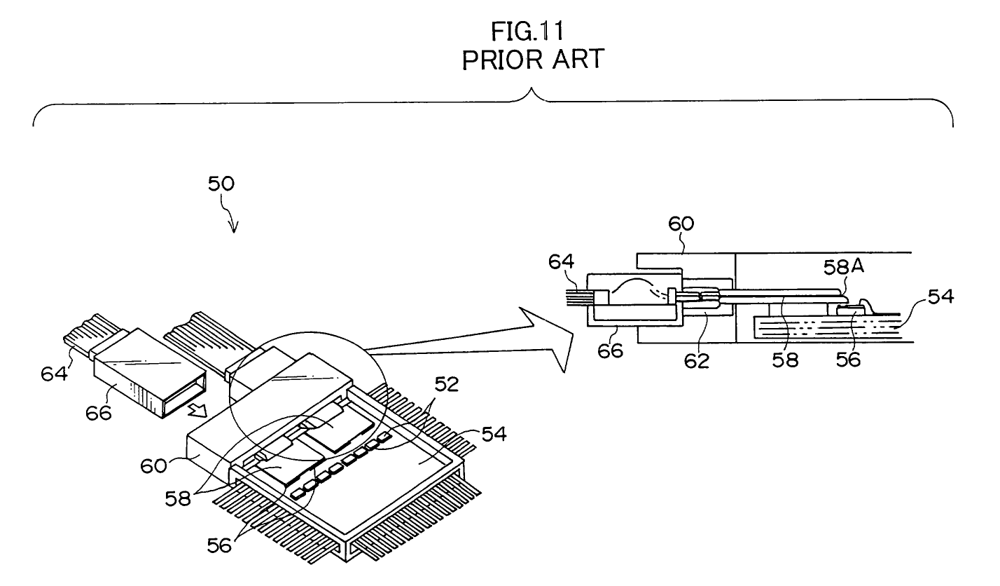

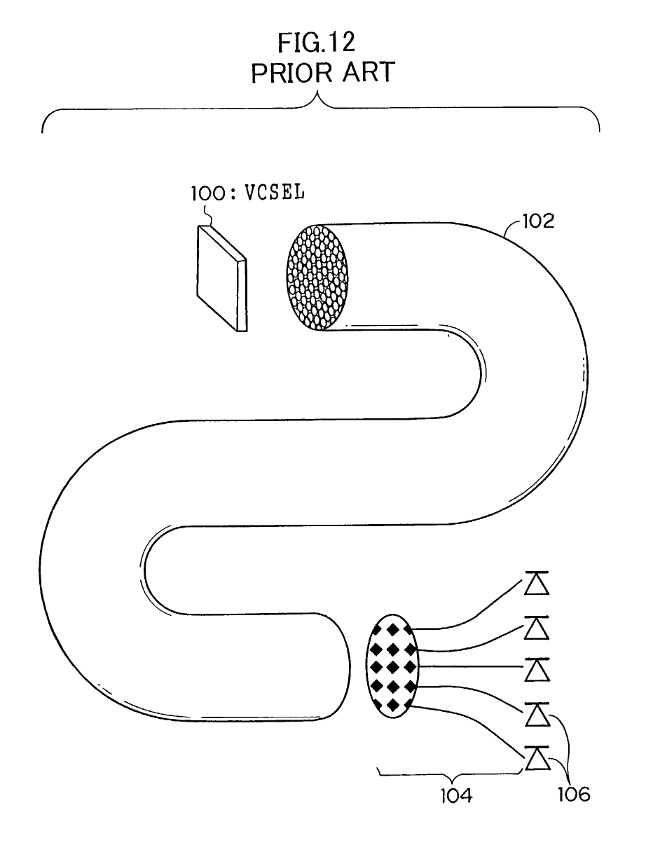

In a third embodiment of the present invention, for example, as shown in FIG. 6, a Y-shaped optical waveguide 40 whose one end branches out in two directions is disposed on the substrate 12, and the organic EL element 22 is provided on one branch of the optical waveguide 40 and the laminated light detector 36 is provided on the other branch thereof using the above-described method. As a result, a monolithically formed optical transceiver can be easily realized.

Next, a fourth embodiment of the present invention will be described in detail referring to drawings. FIG. 7 shows an optical transmission module 110 to which the present invention has been applied.

As shown in FIG. 7, in the optical transmission module 110, optical condensing systems 114 (see FIG. 8) are disposed on one end surface 112A of a multi-channel fiber image guide 112 formed by bundling plural optical fibers. On the end surface 112A provided with the optical condensing systems 114, a transparent electrode layer 116 serving as an anode, an organic-compound layer 118 including a light-emitting layer, and a metal electrode layer 120 serving as a cathode are successively overlaid to form an organic electro-luminescence (EL) element 122. The transparent electrode layer 116, the organic-compound layer 118 and the metal electrode layer 120 respectively correspond to a first electrode layer, a light-emitting layer and a second electrode layer. The organic EL element 122 corresponds to a light-emitting element of the present invention.

As components of the optical transmission module 110 other than those mentioned above may be the same as those of a conventional optical transmission module using a fiber image guide, descriptions thereof will be omitted.

Each of the above-mentioned components will now be described.

The fiber image guide 112 is generally formed by bundling about 3,000 to 100,000 optical fibers each having a small core diameter of about several tens of micrometers so that the diameter of the fiber image guide 112 is about 1 mm, and within the fiber image guide 112 several to several hundred of the optical fibers form one optical transmission line. A glass image guide using quartz glass optical fibers, or a polymeric fiber image guide using plastic optical fibers (POFs) formed from polymers, for example, can be used as the fiber image guide 112. In the fourth embodiment, a polymeric fiber image guide using POFs formed from PMMA, polyimide, or the like is used.

The optical condensing systems 114 are disposed so as to condense light from the organic EL element 122 and emit the light into the end surface 112A of the fiber image guide 112, whereby a number of apertures can be increased. Micro lenses, SELFOC® lenses, or the like can be used as the optical condensing systems 114, and flat surfaces thereof are oriented toward the side from which light is emitted and are bonded using a transparent adhesion layer 115, as shown in FIG. 8.

A material used in the transparent electrode layer 116 is the same as that used in the transparent electrode layer 16 in the first embodiment. The transparent electrode layer 116 can be patterned on the end surface 112A of the fiber image guide 112, which is provided with the optical condensing systems 114, by a well-known method, such as vacuum deposition or sputtering using a mask.

Since structures of the organic-compound layer 118 and the metal electrode layer 120 are the same as those of the organic-compound layer 18 and the metal electrode layer 20 in the first embodiment, descriptions thereof will be omitted.

In the optical transmission module 110 having the above-described structure, when a voltage is applied between the transparent electrode layer 116 and the metal electrode layer 120 of the organic EL element 122 based on signals to be transmitted (transmission signals), the light-emitting layer of the organic-compound layer 118 emits light. In the same manner as in the first embodiment, the applied voltage may be a stationary voltage (including voltage that generates alternative current, as needed) or pulse voltage.

Light that proceeds to the transparent electrode layer 116 is transmitted through the transparent electrode layer 116. Light that proceeds to the metal electrode layer 120 is reflected thereby because the metal electrode layer 120 functions as a total reflection layer, such that the light proceeds to and is transmitted through the transparent electrode layer 116. In other words, almost all of the emitted light can be emitted to a transparent electrode layer 116 side in the organic EL element 122.

The light, which has been transmitted through the transparent electrode layer 116, is condensed and emitted into the end surface 112A of the fiber image guide 112 by the optical condensing systems 114 so as to be introduced to the optical fibers forming the fiber image guide 112. Thus, the light from the organic EL element 122 can be efficiently condensed and emitted into the optical fibers forming the fiber image guide 112 by the optical condensing systems 114.

The light is then transmitted through the fiber image guide 112 (through the optical fibers) toward the other end surface 112B, from which the light is outputted and which is opposite from the end surface 112A. Thus, in the optical transmission module 110, almost all of the light emitted from the light-emitting layer of the organic EL element 122 based on the transmission signals can be introduced to and transmitted by the fiber image guide 112, and only a small quantity of light is lost.

In this manner, when the organic EL element 122, which is formed by overlaying the layers 116, 118 and 120 via vapor deposition or the like on the end surface 112A of the fiber image guide 112 provided with the optical condensing systems 114, is used as a light source in the optical transmission module 110 in place of a surface-emitting laser, the fiber image guide 112 and the light source (the organic EL element 122) can be easily connected to each other via the optical condensing systems 114 without requiring a fixing procedure. Further, if a deposition mask is used during the vapor deposition, the organic EL element 122 can be easily patterned on the end surface 112A of the fiber image guide 112 provided with the optical condensing systems 114. Plural organic EL elements 122 for plural channels can be simultaneously patterned in a single process, being integrally formed with the end surfaces 112A of the fiber image guides 112. Accordingly, a process for mounting the optical transmission module 110 can be considerably shortened, and costs can be reduced.

In the same manner as described in the first embodiment, the organic EL element 122 is also suitably used as a light source in order to efficiently transmit light in the inexpensive polymeric fiber image guide 112.

When light outputted from an organic EL element matrix array, in which the organic EL elements 122 were arranged in a twenty-by-twenty pattern with a pitch of 250 μm, was actually transmitted over a distance of 10 m by the fiber image guide 112 in the above-described manner, mutual crosstalk was not observed even at a distance no greater than about several tens of meters. It can be theoretically confirmed that a transmission speed of at least 100 Mbps per channel can be realized and that a considerably large amount of light, a total of 40 Gbps, can be transmitted.

In the fourth embodiment, an example in which only a low-molecular organic material is used in the organic-compound layer 118 has been described. In the same manner as in the first embodiment, however, a high-molecular material may be used therein.

Further, in the fourth embodiment, an example of the optical transmission module for transmitting light has been described. The present invention, however, is not limited to this example, and the optical transmission module can also be structured as in the following fifth embodiment.

For example, as shown in FIGS. 9 and 10, optical condensing systems 128 for condensing light outputted from the fiber image guide 112 are disposed on the end surface 112B of the fiber image guide 112, from which light is outputted. In the same manner as in the organic EL element 122, a transparent electrode layer 130 serving as an anode is patterned on the end surface 112B provided with the optical condensing systems 128, and a light-detection layer 132 and a metal electrode layer 134 serving as a cathode are successively overlaid thereon via vapor deposition or the like, so as to form a so-called laminated light detector 136. As a result, light which has been transmitted through the fiber image guide 112 can be detected by the light detector 136, making the optical transmission module a so-called total module, which can send and receive light. Micro lenses, SELFOC® lenses, or the like can be used as the optical condensing systems 128. A structure and an operation of the light detector 136 are the same as those of the light detector 36 described in the second embodiment.

In this way, when the light detector 136 is formed in the same laminated manner as the above-described organic EL element 122, the fiber image guide 112 and the light detector 136 can be easily connected to each other via the optical condensing systems 128 without requiring a fixing procedure. Further, if a deposition mask is used, the light detector 136 can be easily patterned on the end surface 112B of the fiber image guide 112. Accordingly, a process for mounting the total module can be shortened, and costs can be reduced.

What is claimed is:

1. An optical transmission module comprising a substrate, an optical waveguide disposed thereon, and a light-emitting element including an organic material, which is overlaid on the optical waveguide.

2. The optical transmission module of claim 1, further comprising a light detector, which is overlaid on the optical waveguide.

3. The optical transmission module of claim 1, wherein the optical waveguide is a polymeric optical waveguide and the light-emitting element is an organic electro-luminescence element.

4. The optical transmission module of claim 2, wherein the optical waveguide is a polymeric optical waveguide and the light-emitting element is an organic electro-luminescence element.

5. An optical transceiver comprising:
a substrate;
a substantially Y-shaped optical waveguide disposed on the substrate;
a light-emitting element including an organic material, which is overlaid on a branch of the Y-shaped optical waveguide; and
a light detector, which is overlaid on another branch of the Y-shaped optical waveguide.

6. The optical transceiver of claim 5, wherein the Y-shaped optical waveguide is a polymeric optical waveguide and the light-emitting element is an organic electro-luminescence element.

7. An optical transmission module comprising:
a fiber image guide, which is formed by bundling plural optical fibers; and
a light-emitting element including an organic material, which is overlaid on an end surface of the fiber image guide.

8. The optical transmission module of claim 7, further comprising a light detector which is overlaid on another end surface of the fiber image guide.

9. The optical transmission module of claim 7, wherein the optical fibers are polymeric optical fibers and the light-emitting element is an organic electro-luminescence element.

10. The optical transmission module of claim 8, wherein the optical fibers are polymeric optical fibers and the light-emitting element is an organic electro-luminescence element.
